(19) United States
(12) Patent Application Publication
(10) Pub. No.: US 2025/0146542 A1
(43) Pub. Date: May 8, 2025

(54) SYSTEM AND METHOD FOR ALIGNING A MAGNETIC DRIVE UNIT

(71) Applicant: Pall Technology UK Limited, Portsmouth (GB)

(72) Inventors: Steven van den Berghe, Hoegaarden (BE); Jorrit Sevenants, Hoegaarden (BE); Koen Eraly, Hoegaarden (BE); Emanuele Cappello, Hoegaarden (BE); Pauly Mertens, Hoegaarden (BE)

(73) Assignee: Pall Technology UK Limited, Portsmouth (GB)

(21) Appl. No.: 18/388,038

(22) Filed: Nov. 8, 2023

(51) Int. Cl. F16D 47/02; F16D 23/12; F16D 27/01

(52) U.S. Cl. CPC F16D 47/02; F16D 23/12; F16D 27/01; F16D 2023/123

(57) ABSTRACT

An apparatus for aligning a bioprocessing drive head includes an assembly of rotating and sliding bearings configured to operatively connect a drive motor to a rotatable shaft, a drive head operatively connected to the rotatable shaft, the drive head configured to rotate an impeller within a bioprocessing vessel. The apparatus further including a linear movement mechanism operatively connected to the rotary ball spline mechanism and/or the rotatable shaft. The linear movement mechanism being configured to move the drive head linearly via the rotatable shaft into operative contact with the impeller, without linearly moving the drive motor.

### CROSS REFERENCE TO RELATED APPLICATIONS

The present patent application is related to concurrently filed, copending, and commonly assigned U.S. Patent Application Nos. and entitled “FLEXIBLE BIOPROCESSING VESSEL AND RIGID SUPPORT STRUCTURE” and “APPARATUS, SYSTEM, AND METHOD FOR TRANSPORTING AND INSTALLING A FLEXIBLE BIOPROCESSING VESSEL” the disclosures of which is incorporated herein by reference.

### BACKGROUND

### Technical Field

Embodiments of the invention relate generally to bioprocessing, and, more particularly, to a system and method for aligning a drive head of a drive motor assembly with an impeller of a bioprocessing vessel.

### DISCUSSION OF ART

Mixers and bioreactors are often employed to carry out biochemical and biological processes and/or manipulate liquids and other products of such processes. These devices typically utilize single-use vessels e.g., flexible or collapsible bags that are supported by an outer rigid support structure such as a stainless-steel housing/tank. As will be appreciated, use of sterilized single use bags eliminates the time-consuming step of cleaning the tank after each use and reduces the chance of contamination.

In use, a disposable/single-use bag is positioned within the rigid tank and filled with the desired fluid for processing. An impeller assembly that includes a rotating impeller having one or more blades is disposed within the bag and is used to mix the fluid. Existing impeller systems are either top-driven, having a shaft that extends downwardly into the bag, on which one or more impellers are mounted, or bottom-driven, having an impeller disposed in the bottom of the bag that is driven by, for example, a magnetic drive system positioned outside the bag.

Magnetically driven impellers typically have a base portion that is secured (e.g., welded) to the bag. The impeller contains permanent magnets that may be rotated to rotate the impeller. The permanent magnets of the impeller are magnetically coupled to and driven by permanent magnets of an external drive motor assembly/drive unit. In use, the drive magnets are rotated which in turn rotates the impeller resulting in agitation of a fluid within the bag. In known magnetic drive systems the drive motor rotates a shaft which is operatively connected to a drive head containing the one or more permanent magnets.

As will be appreciated, during installation of a single-use bag in a support structure/tank, the drive head and motor are not initially in contact with the base portion of the impeller. It is not until after the bag is aligned in the tank, and configured for use, that the drive head is magnetically coupled to the impeller. Typically, for a vessel with a bottom-driven impeller, the drive head is raised into magnetic contact with the impeller.

In known systems, the entire drive motor is linearly raised until the drive head engages the base portion. This is accomplished via a linear actuator attached to the drive motor housing, with the housing and the entire drive motor assembly secured to the tank. This current solution is complex and utilizes an expensive linear module which is potentially prone to inaccuracies. More specifically, the center of gravity of the drive motor assembly is not aligned with the rotational axis of the shaft that is connected to the drive head. Given the relatively heavy weight of the motor (approximately 20 kg or more), and the attachment point of the linear lift system, this creates undesirable eccentric forces on the rotatable shaft and drive head and necessitates a degree of play in the linear actuator to compensate in an attempt to ensure that the drive head may be properly aligned with the impeller. The play, however, may result in inaccurate lifting, placement, and/or alignment of the drive head.

In view of the above, there is a need for a system and method for aligning a drive head with an impeller of a bioprocessing vessel that is accurate and does not require complicated and/or expensive and potentially error prone linear mechanisms that lift the entire drive motor.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of the possible embodiments. Indeed, the disclosure may encompass a variety of forms that may be similar to or different from the embodiments set forth below.

According to an aspect of the invention, an apparatus for aligning a bioprocessing drive head includes an assembly of rotating and sliding bearings configured to operatively connect a drive motor to a rotatable shaft and a drive head operatively connected to the rotatable shaft, the drive head configured to rotate an impeller within a bioprocessing vessel. The apparatus further includes a linear movement mechanism operatively connected to the rotary ball spline mechanism and/or the rotatable shaft. The linear movement mechanism is configured to move the drive head linearly via the rotatable shaft into operative contact with the impeller, without linearly moving the drive motor.

In an embodiment, the assembly of rotating and sliding bearings is a rotary ball spline mechanism.

In an embodiment, the linear movement mechanism is a linear actuator.

In an embodiment, the rotary ball spline mechanism is located within a housing, the housing having a slot and an aperture in an upper housing surface from which the rotatable shaft extends, and the linear actuator is secured to the rotary ball spline mechanism through the slot.

In an embodiment, the impeller may include one or more magnets configured for magnetic coupling to one or more magnets of the drive head when the drive head and the impeller are in operative contact.

In an embodiment, the apparatus further includes a drive motor operatively connected to the rotary ball spline mechanism.

In another embodiment, the linear movement mechanism may be a screw that is operatively connected to the rotatable shaft and the apparatus further includes a brake configured to selectively block rotation of the rotary ball spline mechanism to move the drive head linearly, via the screw and rotatable shaft, into operative contact with the impeller.

In an embodiment, the screw is configured to engage a threaded aperture in the rotatable shaft.

According to another aspect of the invention, a system for aligning and rotating a bioprocessing drive head includes a rigid support structure configured for receiving a flexible bioprocessing vessel having an interior cavity that includes an impeller. The system further includes a drive motor attached to an external surface of the rigid support structure, a rotary ball spline mechanism operatively connecting the drive motor to a rotatable shaft, and a drive head operatively connected to an end of the rotatable shaft opposite from the drive motor, the drive head configured to rotate an impeller within a bioprocessing vessel. The system also includes a linear movement mechanism operatively connected to the rotary ball spline mechanism and/or the rotatable shaft. The linear movement mechanism is configured to move the drive head linearly via the rotatable shaft into operative contact with the impeller, without linearly moving the drive motor and the drive motor is configured to rotate the rotatable shaft and drive head, via the rotary ball spline mechanism, to rotate the impeller.

In an embodiment, the linear movement mechanism is a linear actuator.

In an embodiment, the rotary ball spline mechanism is located within a housing, the housing having a slot and an aperture in an upper housing surface from which the rotatable shaft extends, and the linear actuator is secured to the rotary ball spline mechanism through the slot.

In an embodiment, the impeller includes one or more magnets configured for magnetic coupling to one or more magnets of the drive head when the drive head and the impeller are in operative contact.

In another embodiment, the linear movement mechanism may be a screw that is operatively connected to the rotatable shaft and the system further includes a brake configured to selectively block rotation of the rotary ball spline mechanism to move the drive head linearly, via the screw and rotatable shaft, into operative contact with the impeller.

In an embodiment, the screw is configured to engage a threaded aperture in the rotatable shaft.

According to another aspect of the invention, a method of aligning a bioprocessing drive head includes aligning an impeller of a bioprocessing vessel for magnetic coupling with a drive head of a drive motor located beneath the impeller and external to the bioprocessing vessel, the drive head operatively connected to a rotatable shaft that is in turn operatively connected to the drive motor via a rotary ball spline mechanism. The method further includes moving the drive head linearly into operative engagement with the impeller via a linear movement mechanism that is operatively connected to the rotary ball spline mechanism and/or the rotatable shaft, without linearly moving the drive motor.

In an embodiment, linear movement mechanism is a linear actuator.

In an embodiment, the method further includes rotating the drive head via rotatable shaft and the drive motor to rotate the impeller.

In an embodiment, the method further includes removing the drive head from operative engagement with the impeller via the linear movement mechanism, wherein removing the drive head is accomplished without linearly moving the drive motor.

In an embodiment, the linear movement mechanism is a screw that is engaged with a threaded aperture of the rotatable shaft and the method further includes activating a brake to block rotation of the rotary ball spline mechanism to move the drive head linearly, via the screw and rotatable shaft, into operative engagement with the impeller.

### BRIEF DESCRIPTION OF THE FIGURES

The present invention will be better understood from reading the following description of non-limiting embodiments, with reference to the attached drawings, wherein below:

FIG. 1 is a perspective view of a rigid support structure suitable for use with embodiments of the present invention;

FIG. 2 is an enlarged cross-sectional view of a known magnetic impeller and drive assembly depicting an exemplary magnetic coupling between magnets of a drive head and impeller magnets.

FIG. 3 is a perspective illustration of a known drive motor lift mechanism in which a drive motor linearly moved to couple a drive head with an impeller.

FIG. 4 is a perspective view of an apparatus for aligning a bioprocessing drive head according to an embodiment of the invention.

FIG. 5 is a perspective view of an apparatus for aligning a bioprocessing drive head according to another embodiment of the invention, the view showing the apparatus attached to an outer surface of a support structure for a bioprocessing vessel.

FIG. 6 is a sectioned side view of the apparatus of FIG. 5.

FIG. 7 is a sectioned perspective view of the apparatus of FIG. 5.

FIG. 8 is a side view of a rotary ball spline mechanism according to an embodiment of the invention, the rotary ball spline mechanism configured for use in the apparatus embodiments of FIGS. 4-8.

FIG. 9 is a partially cut away view of a rotary ball spline mechanism depicting internal components of the same.

FIG. 10 is a perspective view of a drive motor suitable for use with embodiments of the invention, the view depicting a mounting surface and rotatable coupling/bore that is rotationally driven by the drive motor and coupled to the rotary ball spline mechanism to rotate the drive head.

FIG. 11 is a side view of the rotary ball spline mechanism illustrating structures that couple the rotary ball spline mechanism to the rotatable coupling/bore of the drive motor.

FIG. 12 is another side view of the rotary ball spline mechanism of FIG. 11.

FIG. 13 is a sectioned view of an end of the rotary ball spline mechanism of FIG. 11.

FIG. 14 is a perspective view of an apparatus for aligning a bioprocessing drive head according to an alternative embodiment of the invention that utilizes a screw and a brake.

FIG. 15 is a sectioned view of the alternative embodiment of FIG. 14.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts.

As used herein, the term “flexible” or “collapsible” refers to a structure or material that is pliable, or capable of being bent without breaking, and may also refer to a material that is compressible or expandable. An example of a flexible structure is a bag formed of polyethylene film.

A “vessel,” as the term is used herein, means a flexible bag, a flexible container, a semi-rigid container, or a rigid container, as the case may be. The term “vessel” as used herein is intended to encompass vessels, (e.g., bioprocessing vessels), having a wall or a portion of a wall that is flexible, single-use flexible bags, as well as other containers or conduits commonly used in biological or biochemical processing, including, for example, cell culture/purification systems, fermentation systems, mixing systems, media/buffer preparation systems, and filtration/purification systems.

As used herein, the term “bag” means a flexible or semi-rigid vessel used, for example, as a mixer or bioreactor for the contents within.

Embodiments may be utilized in connection with a wide variety of biological and chemical processes, which are referred to generally herein as “bioprocessing.” This term encompasses, but is not limited to, the various processes that occur in bioreactors, mixers, fermenters, and the like. A “bioprocessing vessel” is a vessel suitable for use with or in a bioreactor, mixer, fermenter, or other biological or chemical processing device. Certain embodiments may be suitable for use in other industries/applications where size, ease of installation, and/or efficient, versatile mixing of fluids is desirable.

While described as for use in connection with drive motors that utilize permanent magnet containing drive heads, and impellers that include the same, embodiments are not so limited. As will be appreciated, embodiments may be suitable for use with various coupling mechanisms between drive head and impeller, including solely mechanical connections, connections that utilize mechanical and magnetic elements, and other coupling mechanisms.

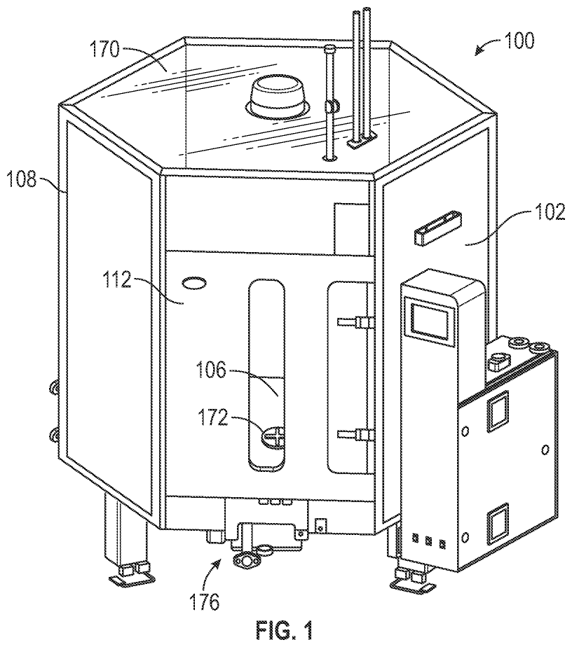

Referring now to FIG. 1, a support structure 100 and flexible bioprocessing vessel 170 suitable for use with embodiments of the invention are depicted. The support structure 100 includes a rigid body 102 having a bottom surface 106 and six rigid panels 108 that form sides surrounding the bottom surface 106 to define a hexagonal interior. The hexagonal interior has a substantially open top and a selectively openable door 112 which allows access to the hexagonal interior and which is configured to receive the flexible bioprocessing vessel. The support structure further includes an exterior facing bottom surface 176 to which various mechanical and/or electrical devices and equipment are located.

While the rigid body 102 is depicted as having a hexagonal exterior, embodiments are not limited to use with support structures or flexible vessels having any specific shape. Indeed, embodiments may be broadly usable with support structures and vessels having a variety of shapes, structures, or configurations including cylindrical, round, and cuboid/cubical vessels/structures. Moreover, while certain embodiments may be particularly suited for use with larger bioprocessing vessels and support structures, e.g., 2000L-3000L, embodiments may be used with larger or smaller bioprocessing vessels/structures.

As shown, the flexible bioprocessing vessel 170 has an interior cavity that is configured to receive fluid for processing. The interior cavity includes an impeller 172, which, in embodiments, has a base portion, or other portion, that includes one or more permanent magnets. The magnets are configured to be coupled to magnets in a drive head of a drive motor, and this magnetic coupling is used to transfer torque from the motor to the impeller 172 to agitate fluid in the bioprocessing vessel.

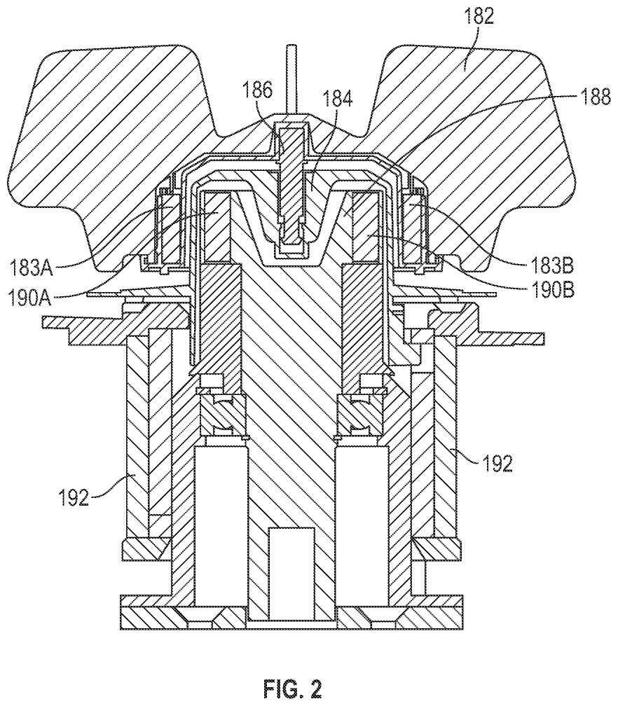

Referring to FIG. 2, a known magnetic coupling is depicted. This coupling is described in U.S. Pat. No. 11,065,589, which is incorporated by reference in its entirety, except to the extent that any of the incorporated material is inconsistent with the express disclosure herein. As shown, an impeller 182 contains a plurality of permanent magnets 183A and 183B. The impeller 182, which is located within a flexible bioprocessing vessel, sits on an impeller seat 184 (also a component of the vessel) that contains a shaft 186 about which the impeller 182 rotates. The impeller seat 184 is secured in place for use via a locking and centering mechanism 192 that is part of a rigid support structure/tank (not shown). The locking and centering mechanism 192 includes a hollow cylindrical housing configured to receive a drive head 188 of a drive motor. In use, the drive head 188 is mechanically raised within the hollow cylindrical housing of the locking and centering mechanism 192 into an interior cavity of the impeller seat. The drive head 188 also contains a plurality of permanent magnets 190A and 190B which engage the permanent magnets of the impeller 182 to establish a magnetic coupling in which rotation of the drive head 188 by the motor rotates the impeller 182 about the shaft 186 to agitate fluid in the vessel. When the bioprocess is complete, the drive head 188 is lowered out of magnetic contact with impeller magnets 183A and 183B so the flexible bioprocessing vessel may be removed from the support structure and disposed.

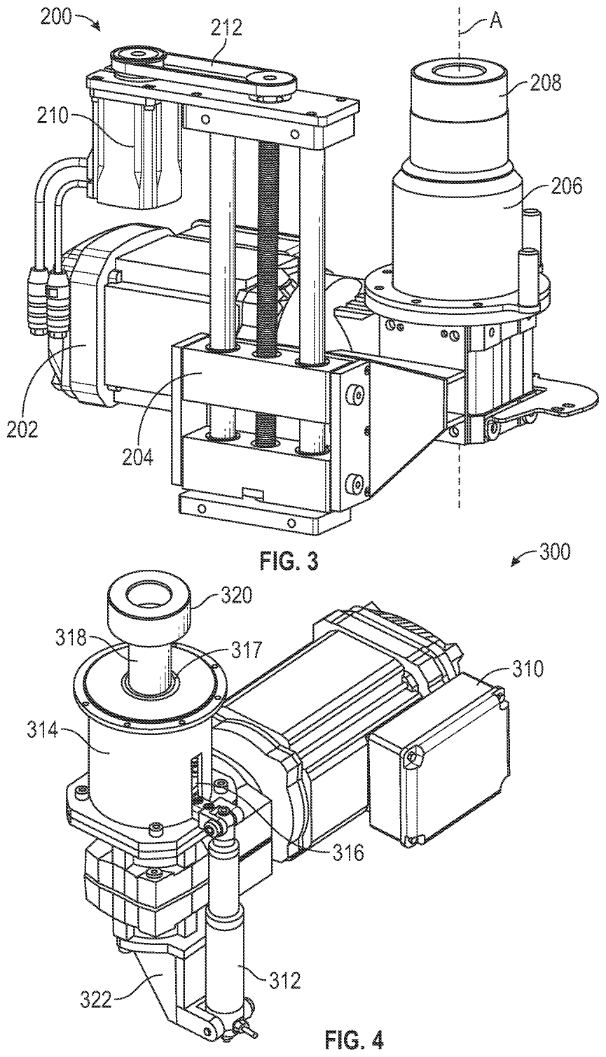

Turning now to FIG. 3, an existing drive head lift mechanism 200 is depicted. In use, the mechanism is attached to an external surface, e.g., an exterior bottom surface, of a support structure. As shown, the drive head lift mechanism includes a drive motor 202 which is operatively connected to a housing within which a rotatable shaft (not shown) resides. The rotatable shaft is operatively connected to a drive head 208. This mechanism further includes a relatively complex linear actuator module 204, which is connected to an end of the drive motor proximate the housing, shaft, and drive head. As shown, the module utilizes a motor 210, a belt drive 212 and multiple additional components. Significantly, in use, the entire drive motor and operatively connected components are linearly raised until the drive head engages the base portion of the impeller.

As mentioned, such lift mechanisms are overly complex and utilize expensive linear modules which are potentially prone to inaccuracies. More specifically, the center of gravity of the entire drive motor assembly is not aligned with the rotational axis of the shaft that is connected to the drive head. Given the relatively heavy weight of the drive motor (approximately 20 kg or more) this creates undesirable eccentric forces on the rotatable shaft and drive head and necessitates a degree of play in the linear actuator to compensate and properly align the drive head. The play, however, cannot fully compensate for the aforementioned forces and, as a result, may result in inaccurate lifting, placement, and/or alignment of the drive head.

Referring now to FIG. 4, an apparatus 300 for aligning a bioprocessing drive head according to an embodiment of the invention is depicted. The apparatus 300 includes a drive motor 310 that is connected to a housing 314, and a linear movement mechanism, which, in the depicted embodiment, is a linear actuator 312. The linear actuator 312 is secured to the drive motor 310 via a bracket 322. The housing 314 contains an assembly of rotating and sliding bearings, e.g., a rotary ball spline mechanism (not shown) which is configured to operatively connect the drive motor to a rotatable shaft 318. The rotatable shaft 318, which extends/retracts from an aperture 317 in the housing 314, is, in turn, operatively connected to a drive head 320, which is configured to rotate an impeller within a bioprocessing vessel. As depicted, the drive head 320 is operatively connected to an end of the rotatable shaft opposite the drive motor.

While embodiments are described as utilizing a rotary ball spline mechanism, in other embodiments, an assembly of rotating and sliding bearings that facilitates rotation of a drive head as well as linear movement of the drive head without the need to linearly move a drive motor may be employed. For example, in embodiments, an assembly of a plain or ball rotating bearing (for rotational movement) and a ball bush or sleeve bearing as a sliding bearing (for linear movement) may be employed.

The linear movement mechanism/linear actuator is operatively connected to the rotary ball spline mechanism and/or the rotatable shaft through the slot 316 formed in the housing 314. In use, the linear movement mechanism is configured to move the drive head linearly (e.g., up/down) via the rotatable shaft into operative contact with the impeller without having to linearly move the drive motor. In this regard, the use of a rotary ball spline mechanism allows the rotatable shaft to accurately move linearly up and down and to rotate to drive the drive head and impeller, making linear movement of the drive motor itself unnecessary.

Indeed, with respect to accuracy, which is facilitated by the use of a rotary ball spline mechanism, it has been found that embodiments provide height accuracy of about +/−0.05 mm and concentricity accuracy of about +/−0.02 mm, both significantly better than the accuracy afforded by the existing mechanisms which linearly move the entire drive motor.

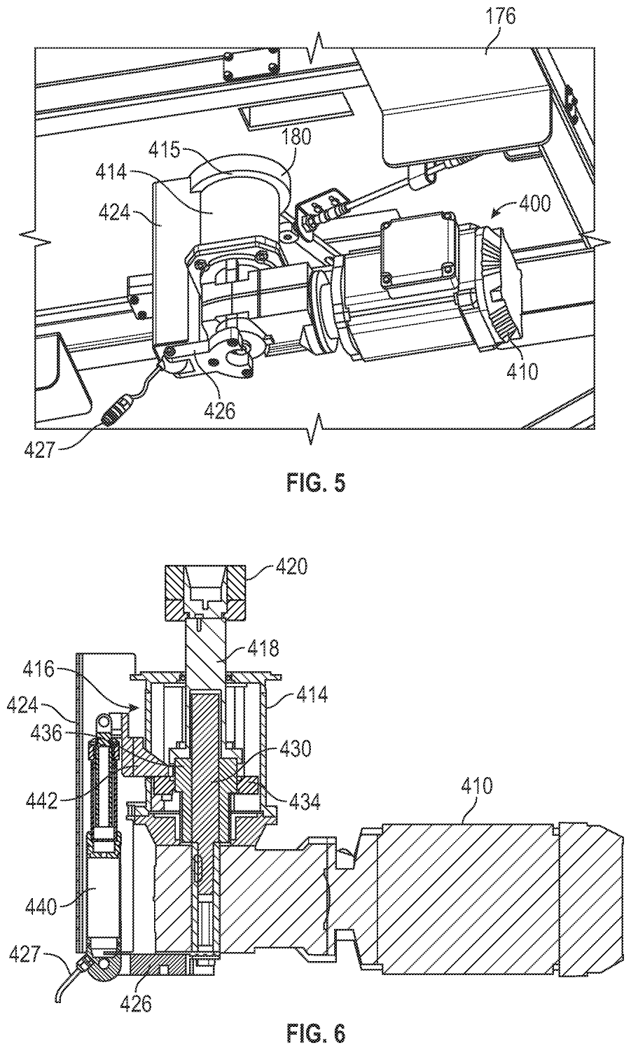

Referring now to FIG. 5 and FIG. 6 an apparatus 400 for aligning a bioprocessing drive head according to another embodiment is depicted. This embodiment is similar to that of FIG. 4 with revisions to the location and configuration of the linear actuator. As shown, the apparatus 400 includes a drive motor 410 that is connected to housing 414 which contains the rotary ball spline mechanism (not shown). In this embodiment, the linear actuator 440 is located within an actuator cover 424. The linear actuator/cover is attached (e.g., bolted) to a lower surface of the drive motor 410 via a bracket 426 and may also be secured to the housing 414. As will be appreciated, the actuator cover 424 need not be shaped or formed as depicted.

In this view, the apparatus 400 is shown attached to the exterior facing bottom surface 176 of the support structure. In particular, the apparatus 400 is attached via a support structure flange 180 which, in turn, is attached to the support structure 100. In embodiments, the support structure flange 180 may be attached to the support structure via fasteners, welded to the support structure, or attached through other means, e.g., integral/formed on the bottom surface. As shown, the apparatus 400 is attached to the support structure 100 via an end flange 415 on the housing 414, which is removably secured to the support structure flange 180 via a plurality of bolts. The apparatus 400 further includes a cable/connector 427 for signal (e.g., MODBUS) and power to the linear actuator 440.

Referring specifically to FIG. 6, which depicts the linear actuator 440, the rotatable shaft 418, and drive head 420, in a lowered or retracted position, multiple components are located within the housing 414. In particular, a ball spline mechanism 430 and rotatable shaft 418 are situated therein. As shown, the ball spline mechanism 430 is operatively connected to the drive motor 410 and to the rotatable shaft 418, which is operatively connected to the drive head 420 at its distal end. In embodiments, the drive head 420 may be selective removable from the rotatable shaft 418 to, for example, replace the drive head based on the type of bioprocessing vessel/impeller utilized. In other embodiments, the drive head 420 may be permanently attached to the rotatable shaft.

The housing 414 includes a slot 416 through which the linear actuator 440 is secured to the rotary ball spline mechanism. In the depicted embodiment, the linear actuator 440 has a foot portion 442 that extends through the slot 416 and is secured (e.g., bolted) to the rotary ball spline mechanism. It is through this connection that the linear actuator 440 moves the rotatable shaft 418 and drive head 420 linearly (e.g., up/down) into operative contact with the impeller without linearly moving the drive motor 410.

As will be appreciated, the size and shape of the slot and foot portion may vary as long as the slot affords sufficient travel to effective raise/lower the drive head in and out of operative contact with the impeller and the foot has sufficient contact with the rotary ball spline mechanism/rotatable shaft to raise or lower the drive head.

In embodiments, the foot portion 442 may be pivotally attached to an end of the linear actuator 440. This may facilitate linear travel within the slot, motion of the rotatable shaft, and/or provide an ease of assembly. As depicted, the foot portion 442 may be secured to the linear actuator via a bolt or other fastener. In embodiments, the foot portion may be incorporated into/formed in a linearly extendable portion of the actuator.

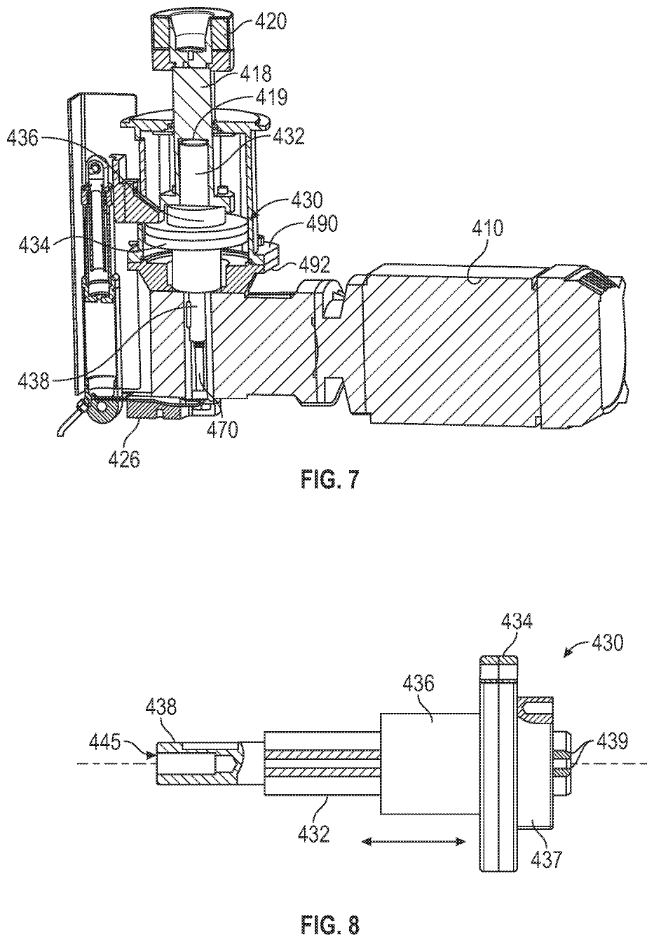

In embodiments, the housing 414 includes a mounting flange 490. The housing 414 may be secured to the drive motor via the mounting flange 490 which is bolted to a motor flange 492 which is part of the drive motor 410 (FIG. 7). In embodiments, the housing 414 may be secured to the motor 410 through other attachment mechanisms and the invention is not so limited.

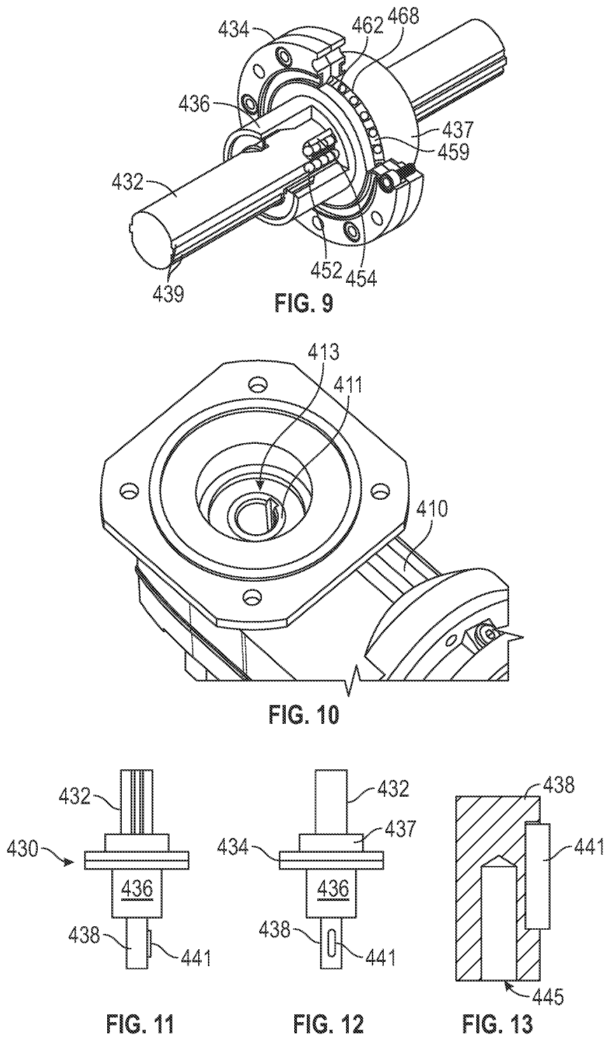

Referring now to FIG. 7, FIG. 8, and FIG. 9, in an embodiment, the ball spline mechanism 430 includes a spline shaft 432 with longitudinally extending channels 439 that are configured to receive ball elements 452 that are held within a retainer 454 that is located within an outer cylinder 436. The ball elements and channels allow the outer cylinder 436 to move linearly up and down relative to the spline shaft 432 which is linearly fixed.

The outer cylinder 436 also includes a circumferential groove 468 that has a plurality of roller elements 459 therein. An installation flange 434 is mounted on the outer cylinder 436. The installation flange 434 has an internal channel 462 that allows the outer cylinder 436 to rotate relative to the installation flange 434, which itself does not rotate as it is rotationally fixed in the current embodiment. In embodiments, the foot portion 442 is attached to the installation flange 434 via one or more bolts and moves the outer cylinder 436 up and down linearly.

The rotatable shaft 418 is secured (e.g., bolted) to an upper portion 437 of the outer cylinder 436. In particular, the rotatable shaft 418 is connected via a shaft flange 460 that is fastened (e.g., bolted) to the upper portion 437 of the outer cylinder 436 via fastener holes 466. The rotatable shaft 418 further includes a shaft bore 419 that is sized to receive the spline shaft 432 and allow the rotatable shaft 418 to move linearly up and down relative to the linearly fixed spline shaft when the outer cylinder 436 is moved linearly via the foot portion 442 and linear actuator. The shaft bore 419 is sized and shaped to provide a relatively close fit with the spline shaft 432 while not interfering with or constricting linear movement of the two components relative to one another.

In this regard, the linear actuator moves the outer cylinder 436 linearly relative to the linearly fixed spline shaft via the foot portion/installation flange connection. The outer cylinder 436 is attached to the rotatable shaft 418 and drive head 420 such that those components also move linearly with the outer cylinder 436 about the spline shaft. The spline shaft, however, while fixed linearly is capable of rotation via the drive motor, and when the spline shaft rotates, it rotates the outer cylinder 436 to which the rotatable shaft and drive head are attached.

Referring now to FIG. 10, FIG. 11, FIG. 12, and FIG. 13, the spline shaft 432 further includes a reduced diameter portion 438 that is configured to engage the drive motor 410 enabling the motor to rotate the spline shaft/outer cylinder 436/rotatable shaft 418 assembly. More specifically, the reduced diameter portion 438 includes a protrusion 441 which is configured, e.g., sized/shaped, to fit into a recess 413 in a rotatable drive bore 411 in the drive motor 410 (FIG. 10).

The reduced diameter portion 438 further includes a bore 445 configured to receive a fastener 470 to secure the rotary ball spline mechanism 430 to the drive motor 410 (FIG. 7). As will be appreciated, the size and shape of the protrusion 441 may vary and the invention is not so limited. The shape/size of the protrusion 441 is dictated by the dimensions and shape of the recess 413 or other keying structure in the bore 445. In other embodiments, different mechanisms for joining the spline shaft to the drive motor may be employed and embodiments are not limited to any specific configuration.

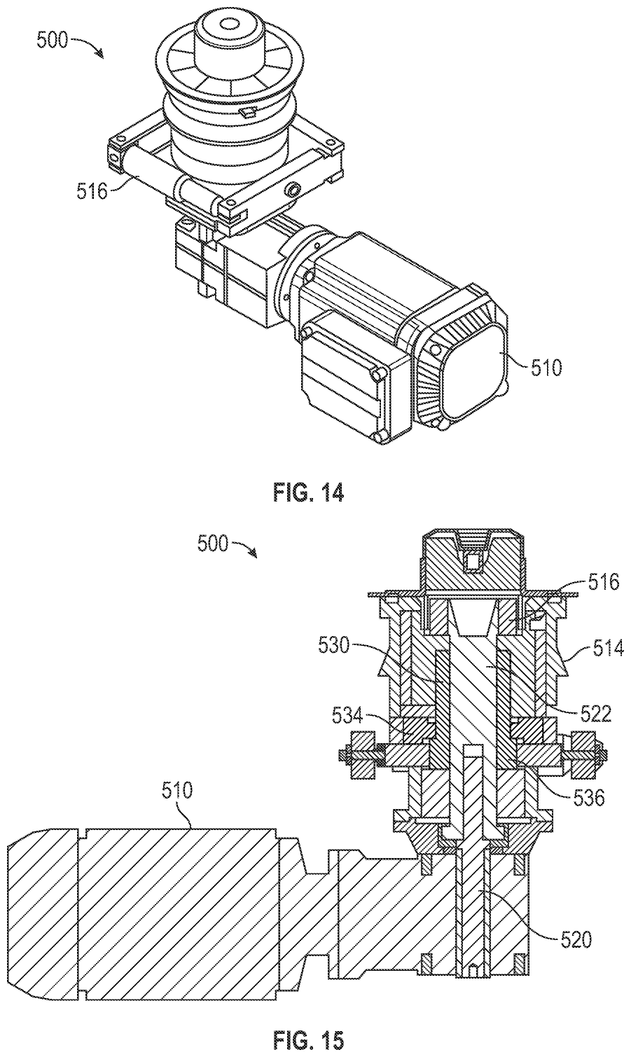

Referring now to FIGS. 14 and 15, an alternative embodiment of the inventive apparatus 500 for aligning a bioprocessing drive head is depicted. This embodiment utilizes a housing 514 that contains a rotatable shaft 522 located within a ball spline mechanism 530. The rotatable shaft 522 is operatively connected to a drive head 516 and capable of rotating the drive head to rotate an impeller within a bioprocessing vessel.

The rotatable shaft 522 has a threaded aperture into which a screw 520 is received. The screw 520, which functions as a linear movement mechanism, sits in the rotating bore of the drive motor and is rotated by the motor to raise or lower the rotatable shaft 522 within the ball spline mechanism 530 to raise or lower the drive head. As will be appreciated, the motor is reversed to raise or lower the rotatable shaft and drive head.

Rotation of the rotary bearing of the ball spline mechanism can be blocked by activating a brake 526 so that the outer cylinder 536 of the ball spline mechanism does not rotate when the screw 520 is rotated so that the rotary shaft is raised or lowered. In particular, the screw 520 is engaged in a threaded bore, e.g., female screw portion of the rotatable shaft 522. The brake can block the rotation of the rotary ball spline. This means that when the brake in activated, the rotation of the rotatable shaft 522 is blocked. When the brake is activated, the vertical displacement of the outer cylinder 536 the bearing of the rotary ball spline is also blocked. In these conditions, if the screw 520 is rotated, the rotatable shaft 522 will be moved up or down (screw or unscrew). Such vertical movement is not constrained by the outer cylinder 536 of the ball spline.

Embodiments of the inventive apparatus are manufactured from a durable material, e.g., metal, though the invention is not limited any specific material. As will be appreciated in certain embodiments, other ball spline mechanisms may be utilized without departing from the invention. Embodiments of the invention are not limited to a specific type of linear actuator and a variety may be employed. In a specific embodiment, a known 24 VDC in line linear actuator having a stroke length of 50 mm may be used. Embodiments are likewise not limited to a specific drive motor. In a specific embodiment, the drive motor is an AC motor with a helical bevel gear unit. The motor has a power output of 0.75 kW and a torque output of 22 Nm.

Embodiments of the invention also contemplate a method of aligning a bioprocessing drive head which includes an initial step of aligning an impeller of a bioprocessing vessel for magnetic coupling with a drive head of a drive motor assembly located beneath the impeller and external to the bioprocessing vessel. The drive head operatively connected to a rotatable shaft that is in turn operatively connected to the drive motor via a rotary ball spline mechanism. The method further includes moving the drive head linearly into operative engagement with the impeller via a linear movement mechanism that is operatively connected to the rotary ball spline mechanism and/or the rotatable shaft, without linearly moving the drive motor. The method also includes rotating the drive head via the rotatable shaft and drive motor to rotate the impeller to agitate fluid in the bioprocessing vessel. The method may also include removing the drive head from operative engagement with the drive head, which is accomplished without linearly moving the drive motor.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. While the dimensions and types of materials described herein are intended to define the parameters of the invention, they are by no means limiting and are exemplary embodiments. Many other embodiments will be apparent to those of skill in the art upon reviewing the above description.

The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

Moreover, in the following claims, terms such as “first,” “second,” “upper,” “lower,” “bottom,” “top,” etc. are used merely as labels, and are not intended to impose numerical or positional requirements on their objects. Further, the limitations of the following claims are not written in means-plus-function format and are not intended to be interpreted as such, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal language of the claims.

1. An apparatus for aligning a bioprocessing drive head comprising:
An assembly of rotating and sliding bearings configured to operatively connect a drive motor to a rotatable shaft;
a drive head operatively connected to the rotatable shaft, the drive head configured to rotate an impeller within a bioprocessing vessel; and
a linear movement mechanism operatively connected to the assembly of rotating and sliding bearings and/or the rotatable shaft;
wherein the linear movement mechanism is configured to move the drive head linearly via the rotatable shaft into operative contact with the impeller, without linearly moving the drive motor.

2. The apparatus of claim 1, wherein the assembly of rotating and sliding bearings is a rotary ball spline mechanism.

3. The apparatus of claim 2, wherein the linear movement mechanism is a linear actuator.

4. The apparatus of claim 3, wherein the rotary ball spline mechanism is located within a housing, the housing having a slot and an aperture in an upper housing surface from which the rotatable shaft extends;
wherein the linear actuator is secured to the rotary ball spline mechanism through the slot.

5. The apparatus of claim 1, wherein the impeller includes one or more magnets configured for magnetic coupling to one or more magnets of the drive head when the drive head and the impeller are in operative contact.

6. The apparatus of claim 2, further comprising a drive motor operatively connected to the rotary ball spline mechanism.

7. The apparatus of claim 2, wherein the linear movement mechanism is a screw that is operatively connected to the rotatable shaft and the apparatus further comprises:
a brake configured to selectively block rotation of the rotary ball spline mechanism to move the drive head linearly, via the screw and rotatable shaft, into operative contact with the impeller.

8. The apparatus of claim 7, wherein the screw is configured to engage a threaded aperture in the rotatable shaft.

9. A system for aligning and rotating a bioprocessing drive head comprising:
a rigid support structure configured for receiving a flexible bioprocessing vessel having an interior cavity that includes an impeller;
a drive motor attached to an external surface of the rigid support structure;
a rotary ball spline mechanism operatively connecting the drive motor to a rotatable shaft;
a drive head operatively connected to an end of the rotatable shaft opposite from the drive motor, the drive head configured to rotate an impeller within a bioprocessing vessel;
a linear movement mechanism operatively connected to the rotary ball spline mechanism and/or the rotatable shaft; and
wherein the linear movement mechanism is configured to move the drive head linearly via the rotatable shaft into operative contact with the impeller, without linearly moving the drive motor;
wherein the drive motor is configured to rotate the rotatable shaft and drive head, via the rotary ball spline mechanism, to rotate the impeller.

10. The system of claim 9, wherein the linear movement mechanism is a linear actuator.

11. The system of claim 10, wherein the rotary ball spline mechanism is located within a housing, the housing having a slot and an aperture in an upper housing surface from which the rotatable shaft extends;
wherein the linear actuator is secured to the rotary ball spline mechanism through the slot.

12. The system of claim 9, wherein the impeller includes one or more magnets configured for magnetic coupling to one or more magnets of the drive head when the drive head and the impeller are in operative contact.

13. The system of claim 9, wherein the linear movement mechanism is a screw that is operatively connected to the rotatable shaft and the system further comprises:
a brake configured to selectively block rotation of the rotary ball spline mechanism to move the drive head linearly, via the screw and rotatable shaft, into operative contact with the impeller.

14. The system of claim 13, wherein the screw is configured to engage a threaded aperture in the rotatable shaft.

15. A method of aligning a bioprocessing drive head comprising:
aligning an impeller of a bioprocessing vessel for magnetic coupling with a drive head of a drive motor located beneath the impeller and external to the bioprocessing vessel, the drive head operatively connected to a rotatable shaft that is in turn operatively connected to the drive motor via a rotary ball spline mechanism; and
moving the drive head linearly into operative engagement with the impeller via a linear movement mechanism that is operatively connected to the rotary ball spline mechanism and/or the rotatable shaft, without linearly moving the drive motor.

16. The method of claim 15, wherein linear movement mechanism is a linear actuator.

17. The method of claim 15, further comprising:
rotating the drive head via rotatable shaft and the drive motor to rotate the impeller.

18. The method of claim 15, further comprising:
removing the drive head from operative engagement with the impeller via the linear movement mechanism, wherein removing the drive head is accomplished without linearly moving the drive motor.

19. The method of claim 15, wherein the linear movement mechanism is a screw that is engaged with a threaded aperture of the rotatable shaft and the method further comprises:
activating a brake to block rotation of the rotary ball spline mechanism to move the drive head linearly, via the screw and rotatable shaft, into operative engagement with the impeller.
